(19) United States
(12) Patent Application Publication
(10) Pub. No.: US 2023/0036764 A1
(43) Pub. Date: Feb. 2, 2023

(54) Systems and Method for Evaluating and Selectively Distilling Machine-Learned Models on Edge Devices

(71) Applicant: Google LLC, Mountain View, CA (US)

(72) Inventor: Matthew Sharifi, Kilchberg (CH)

(21) Appl. No.: 17/787,074

(22) PCT Filed: Dec. 20, 2019
(86) PCT No.: PCT/US2019/067738

§ 371 Date: Jun. 17, 2022

(51) Int. Cl. G06N 3/08; G06N 3/04

(52) U.S. Cl. CPC G06N 3/084; G06N 3/0454

(57) ABSTRACT

The present disclosure provides systems and methods for evaluating and selectively distilling machine-learned models on edge devices. A method can include executing, by a user computing device of a computing system, a teacher machine-learned model stored by the user computing device to produce output data from input data; evaluating, by the computing system, a characteristic of one or more of the user computing device and the teacher machine-learned model; determining, by the computing system based on the evaluation, to train a student machine-learned model that is stored by the user computing device; and training, by the user computing device, the student machine-learned model based on the teacher machine-learned model.

### FIELD

The present disclosure relates generally to user data and machine learning. More particularly, the present disclosure relates to systems and method for evaluating and selectively distilling machine-learned models on edge devices.

### BACKGROUND

User computing devices such as, for example, smart phones, tablets, and/or other mobile computing devices continue to become increasingly: (a) ubiquitous; (b) computationally powerful; (c) endowed with significant local storage; and (d) privy to potentially sensitive data about users, their actions, and their environments. In addition, applications delivered on mobile devices are also increasingly data-driven. For example, in many scenarios, data that is collected from user computing devices is used to train and evaluate new machine-learned models, personalize features, and compute metrics to assess product quality.

Many of these tasks have traditionally been performed centrally (e.g., by a server computing device). In particular, in some scenarios, data can be uploaded from user computing devices to the server computing device. The server computing device can train various machine-learned models on the centrally collected data and then evaluate the trained models. The trained models can be used by the server computing device or can be downloaded to user computing devices for use at the user computing device. In addition, in some scenarios, personalizable features can be delivered from the server computing device. Likewise, the server computing device can compute metrics across users on centrally logged data for quality assessment.

However, frequently it is not known exactly how data will be useful in the future and, particularly, which data will be useful. Thus, without a sufficient history of logged data, certain machine-learned models or other data-driven applications may not be realizable. Stated differently, if a certain set or type of data that is needed to train a model, personalize a feature, or compute a metric of interest was not logged, then even after determining that a certain kind of data is useful and should be logged, there is still a significant wait time until enough data to be generated to enable such training, personalization, or computation.

One possible response to this problem would be to log any and all data centrally. However, this response comes with its own drawbacks. In particular, users use their mobile devices for all manner of privacy-sensitive activities. Mobile devices are also increasingly sensor-rich, which can result in giving the device access to further privacy-sensitive data streams from their surroundings. Thus, privacy considerations suggest that logging should be done prudently — rather than wholesale - to minimize the privacy risks to the user.

Beyond privacy, the data streams these devices can produce are becoming increasingly high bandwidth. Thus, in many cases it is simply infeasible to stream any and all user data to a centralized database, even if doing so was desirable.

### SUMMARY

Aspects and advantages of embodiments of the present disclosure will be set forth in part in the following description, or can be learned from the description, or can be learned through practice of the embodiments.

In one aspects, the present disclosure is directed to a computer-implemented method including executing, by a user computing device of a computing system, a teacher machine-learned model stored by the user computing device to produce output data from input data; evaluating, by the computing system, a characteristic of one or more of the user computing device and the teacher machine-learned model; determining, by the computing system and based on the evaluation, to train a student machine-learned model that is stored by the user computing device; and training, by the user computing device, the student machine-learned model based on the teacher machine-learned model.

In another aspect, the present disclosure is directed to a computer-implemented method including deploying, by a computing system comprising one or more computing devices comprising a user computing device, a current variant of a machine-learned model on the user computing device of the computing system to generate predictions based on user-specific data at the user computing device. The method can include performing one or more iterations including: generating, by the computing system, an additional variant of the machine-learned model that has at least one of a smaller storage size or a faster runtime than the current variant; training, at the user computing device, the additional variant based at least in part on the predictions generated by the current variant of the machine-learned model based on the user-specific data at the user computing device; and replacing, at the user computing device, the current variant of the machine-learned model with the additional variant.

In another aspect, the present disclosure is directed to a user computing device including one or more processors and one or more non-transitory computer-readable media that collectively store instructions that, when executed by the one or more processors, cause the user computing device to perform operations. The operations can include executing a teacher machine-learned model stored by the user computing device to produce output data from input data; evaluating a characteristic of one or more of the user computing device and the teacher machine-learned model; determining, based on the evaluation of the characteristic, to train a student machine-learned model that is stored by the user computing device; and training the student machine-learned model based on the teacher machine-learned model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system for evaluating and distilling machine-learned models on edge devices, according to example embodiments of the present disclosure.

FIG. 1B depicts a block diagram of an example computing device for evaluating and selectively distilling machine-learned models on edge devices, according to example embodiments of the present disclosure.

FIG. 1C depicts a block diagram of an example computing device for evaluating and selectively distilling machine-learned models on edge devices, according to example embodiments of the present disclosure.

FIG. 2 depicts a block diagram of an example training configuration for training a machine-learned student model based on a teacher machine-learned model, according to example embodiments of the present disclosure.

FIG. 3 depicts a flow chart diagram of an embodiment of a method for evaluating and selectively distilling machine-learned models on edge devices, according to example embodiments of the present disclosure.

FIG. 4 depicts a flow chart diagram of another embodiment of a method for training a machine-learned student model based on a teacher machine-learned model, according to example embodiments of the present disclosure.

### DETAILED DESCRIPTION

### Overview

Generally, the present disclosure is directed to the distillation of machine-learned models on a user computing device and/or based on locally logged data. The systems and methods of the present disclosure can include selectively training a student machine-learned model based on a teacher machine-learned model on the user computing device to distill the teacher machine-learned model into a smaller and/or faster model more suitable for execution on an edge device. For example, the student machine-learned model can be trained when the teacher machine-learned model is running too slow and/or taking up too much space on the edge device (e.g., user computing device). Thus, the machine-learned model can be selectively and/or automatically distilled on the computing device when such distillation can provide a smaller replacement machine-learned model for execution on the user computing device.

Aspects of the training can also optionally be based on the evaluation of the user computing device and/or teacher machine-learned model. For instance, the student machine-learned model can be iteratively trained until the student machine-learned model satisfies one or more criteria, which can be based on characteristics of the teacher machine-learned model (e.g., performance, size, etc.) and/or the user computing device (e.g., available storage space, target inference time when executed on the user computing device). Further, the student machine-learned model can be trained based on user-specific data collected by the user computing device. As a result, the student machine-learned model can be customized for the user. The student machine-learned model can also be more compact than the teacher machine-learned model while still providing sufficiently accurate results and, in some instances, providing more accurate results than the teacher machine-learned model.

More specifically, in some implementations, the method can include executing, by a user computing device, a teacher machine-learned model stored by the user computing device to produce output data from input data. For instance, the teacher machine-learned model can perform text recognition/analysis, voice recognition/analysis, image recognition/analysis, personal assistant functions, and/or any other suitable functions on the user computing device.

The method can include evaluating a characteristic of one or more of the user computing device and the teacher machine-learned model. The method can include determining, based on the evaluation, to train the student machine-learned model, for example to replace the teacher machine-learned model on the user computing device. The evaluated characteristics can include a variety of characteristics of the user computing device and/or teacher machine-learned model. As one example, a characteristic of the teacher machine-learned model can include one or more model performance metrics associated with executing the teacher machine-learned model on the user computing device. For instance, the model performance metric can include an inference time of the teacher machine-learned model, such as an average inference time for the teacher machine-learned model. When the average inference time for the teacher-machine learned model is above a threshold inference time, the computing system can determine to generate and/or train the student machine-learned model. Thus, the student machine-learned model can be selectively generated and/or trained to replace the teacher machine-learned model.

In some implementations, the evaluated characteristic can be or include a characteristic of the user computing device. For example, a decision be made to generate and/or train the student machine-learned model to replace the teacher machine-learned model when the user computing device is not performing satisfactorily (e.g., poor battery life, limited on-device storage available, etc.). Such unsatisfactory performance can be caused or worsened by the computational demands of the teacher machine-learned model. Thus, the evaluated characteristic can include one or more metrics associated with a battery life of the user computing device. When the battery life (e.g., average time that the user computing device can function normally without being charged) is detected to be below a threshold metric, a decision can be made to generate and train the student machine-learned model to replace the teacher machine-learned model such that the student machine-learned model can reduce battery consumption to improve the battery life of the user device. However, generating and training of the student machine-learned model will generally be performed when the user computing device is being charged, has a full battery life, and/or is not being used by the user.

As another example, the evaluated characteristic can be or include a processor capability and/or capacity of the user computing device. The student machine-learned model can be trained in response to determining that a processor of the user computing device has insufficient processor capability to execute the teacher machine-learned model within a desired time interval (e.g., total flops per second achievable by the processor, number of cores of the processor, etc.). For instance, a large teacher machine-learned model can be deployed to a variety of user devices having varying processor capabilities and/or memory capacities (e.g., random-access memory, storage memory, etc.). The teacher models can be used to locally train student machine-learned models that are customized based on the respective processor capabilities and/or memory capacities of the device.

In some implementations, the evaluated characteristic can be or include a quantity of training data available to train the student machine-learned model. As described below, the training data can include user-specific data collected at the user computing device, for example during execution of the teacher machine-learned model. The user-specific data can include a user’s response to an output from the teacher machine-learned model. As an example, the teacher-machine-leamed model can provide an output that describes a suggested auto-completion for text being entered by the user (e.g., the next word in a text string being entered by the user for a text message, e-mail or the like). The training data can include which word the user selects such that the training data describes the user’s writing style or preferences. As another example, the training data can voice recognition data that includes words that were incorrectly recognized by the teacher machine-learned model and corrected by the user and/or words that were correctly recognized by the teacher machine-learned model and confirmed as correct by the user. Thus, the training data can include input data, output data, and/or user-feedback data with respect to the teacher machine-learned model.

In some implementations, the student machine-learned model can be trained based on the teacher machine-learned model. The student machine-learned model can be trained based on training data that can includes the input data input into the student machine-learned model and/or output data (e.g., describing one or more inferences) received from the student machine-learned model. In other words, user-specific training examples can be generated by the teacher machine-learned model as the teacher machine-learned model performs operations.

In some implementations, the student machine-learned model can be transmitted to the user computing device, for example, in response to the determination based on the evaluation of the characteristic of the user computing device and/or teacher machine-learned model. The student machine-learned model can be transmitted from a server computing device or other computing device, for example in response to a request for the student machine-learned model. Alternatively, the user computing device can transmit data describing the user computing device and/or teacher machine-learned model to a server computing device, which can evaluate the characteristic(s) to determine that the student machine-learned model should be trained at the user computing device.

In other implementations, the student machine-learned model can be generated on the user computing device. For example, the student machine-learned model can be initiated (e.g., with randomized values).

In some implementations, one or more target characteristics of the student machine-learned model can be selected based on the evaluation of the characteristic(s) of the user computing device and/or teacher machine-learned model. Example target characteristics can include a target storage size of the student machine-learned model, a target inference time of the student machine-learned model, or the like. The target storage size of the student machine-learned model can be selected based on an available storage space of the user computing device, available random access memory (RAM) of the user computing device, and/or available processor cache memory of the user computing device. The characteristics of the student machine learning model may be selected to be optimized to run on specific hardware of the user computing device. For example, the student machine learning model may be optimized to run on a specific processor chipset present in the user computing device and/or application specific integrated circuits (ASICs) present in the user computing device.

As another example, the target characteristic(s) of the student machine-learned model can include a kernel size of a layer(s) of the student machine-learned model, a kernel depth of the layer(s), and/or a number of the layer(s). As a further example, an additional target characteristic can include a number of depthwise separable layers and a number of non-separable layers. Thus, the target characteristics can be selected to adjust the structure and/or configuration of the student machine-learned model.

One or more of these target characteristics can be selected to provide a student machine-learned model that is suitable for the particular user computing device (e.g., can be executed within a threshold time interval, stored with a threshold memory size) and/or suitable for the type of task and/or particular task that the teacher model was trained to perform.

In some implementations, the method can include replacing, at the user device, the teacher machine-learned model with the student machine-learned model. The student machine-learned model can perform the same or similar operations as the teacher machine-learned model yet can require less inference time, computing resources, and/or storage space. Replacing the teacher machine-learned model with the student machine-learned model can include deleting the teacher machine-learned model from the user computing device and/or transmitting teacher machine-learned model for storage at a storage location that is distinct from the user computing device (e.g., a cloud computing storage location). As another example, the teacher machine-learned model can be stored or achieved at the user computing device in a compressed file format.

In some implementations, training of the student machine-learned model based on the teacher machine-learned model can be periodically repeated, for example to re-calibrate the student machine-learned model. The student machine-learned model can be implemented as the user computing device to perform operations previously performed by the teacher machine-learned model. However, the student machine-learned model may not be as suited as the teacher machine-learned model for further personalization for the user (e.g., as the user’s preferences change). In such instances, the teacher machine-learned model can be re-trained based on new user data (e.g., after being re-deployed to the user computing device). Once the teacher machine-learned model has been updated and/or is performing as desired, the student machine-learned model can be re-trained based on the updated teacher machine-learned model.

According to another aspect of the present disclosure, a method can include deploying a current variant of a machine-learned model on a user device of the computing system to generate predictions based on user-specific data at the user device. The current variant can be used to perform functions for the user computing device, such as text recognition/analysis, voice recognition/analysis, image recognition/analysis, personal assistant functions, and/or any other suitable functions. The method can include iteratively generating and training additional variants of the machine-learned model (e.g., until the additional variant satisfies one or more criteria). The additional variant of the machine-learned model that has at least one of a smaller storage size or a faster runtime than the current variant. The additional variant can generally correspond with the student machine-learned model, and the current variant can generally correspond with the teacher machine-learned model described above. Thus, additional variants of the machine-learned model can be iteratively generated and trained.

The additional variant can be generated by the user computing device or a separate computing device (e.g., a server computing device). The method can include training, at the user device, the additional variant based at least in part on the predictions generated by the current variant of the machine-learned model based on the user-specific data at the user device. The user-specific data can be descriptive of user preferences, user-feedback, or the like. The additional variant can be trained as a student machine-learned model of the current variant of the machine-learned model.

In some implementations, the iterations can be performed until a performance metric of the additional variant satisfies one or more threshold criteria. For example, the iterations can be performed until the storage size and/or an inference time of the additional variant falls below a threshold value. As another example, the iterations can be performed until an accuracy of the additional variant is greater than an accuracy threshold. In some implementations, training can continue until a combination of two or more metrics are satisfied. Training parameters can be adjusted during training, if necessary, to achieve the desired combination of threshold criteria.

The systems and methods of the present disclosure can provide a number of technical effects and benefits, including more efficiently using computing resources on edge devices. Distillation of the machine-learned model can provide a smaller, faster model for execution on the user computing device. Execution of the smaller, faster model can consume fewer resources than the original model (e.g., teacher model). Additionally, by performing distillation of the machine learning model on the edge device, data security can be enhanced by preventing third parties having access to user sensitive data during distillation of a personalized student model. Furthermore, selective distillation of the machine-learned model can use fewer computational resources associated with distillation as compared with more frequent and/or regular distillation of models on edge devices. The distillation can be performed based on an evaluation of a characteristic of one or more of the user computing device on which model is stored and/or executed and/or based on a characteristic of the teacher machine-learned model. Thus, distillation can be performed only when such distillation would reduce execution time and/or reduce the size of the resulting model. As a result, computational resources associated with distilling the model and executing the model can be reduced.

The systems and methods of the present disclosure can be included or otherwise employed within the context of an application, a browser plug-in, or in other contexts. Thus, in some implementations, the models of the present disclosure can be included in or otherwise stored and implemented by a user computing device such as a laptop, tablet, or smartphone. As yet another example, the models can be included in or otherwise stored and implemented by a server computing device that communicates with the user computing device according to a client-server relationship. For example, the models can be implemented by the server computing device as a portion of a web service (e.g., a web email service).

With reference now to the Figures, example embodiments of the present disclosure will be discussed in further detail.

### Example Devices and Systems

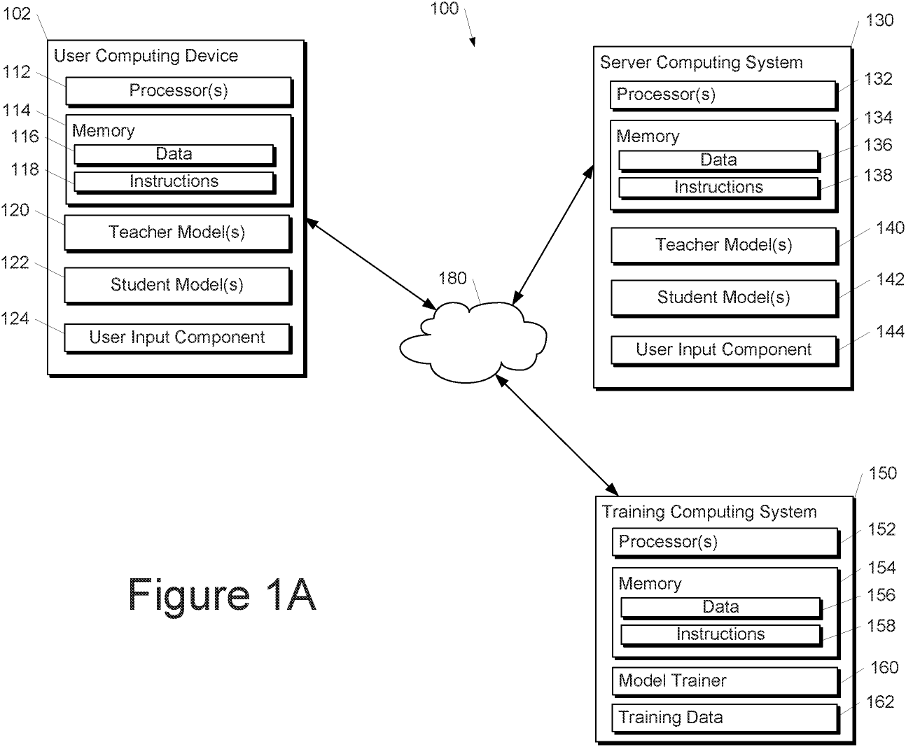

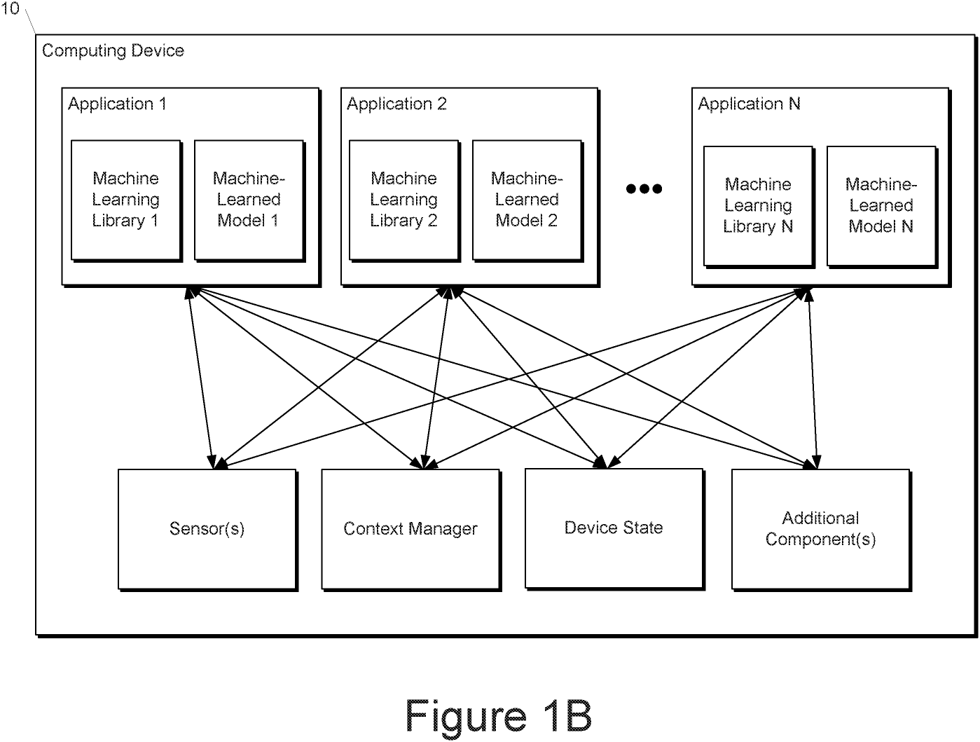

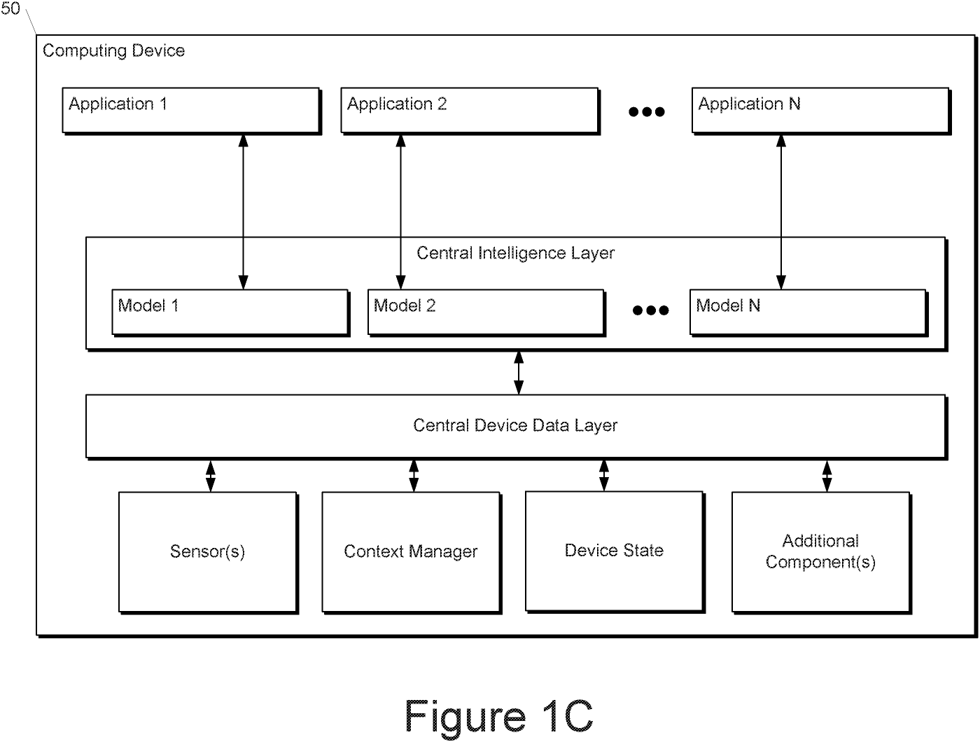

FIG. 1A depicts a block diagram of an example computing system 100 for distillation of machine-learned models on a user computing device and/or based on locally logged data, according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

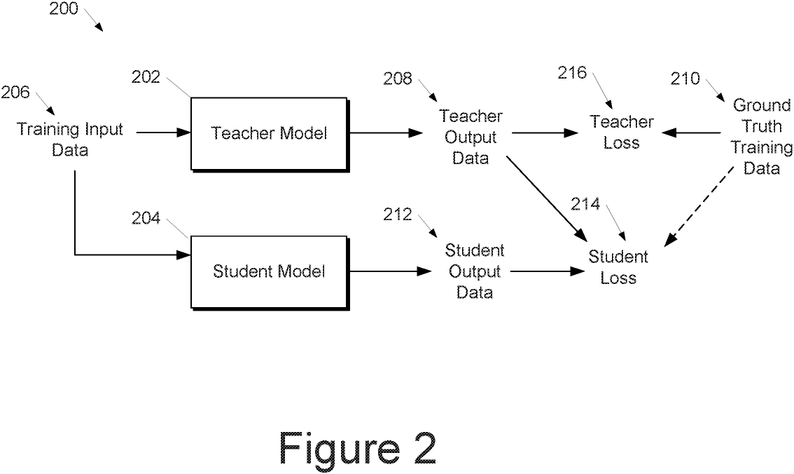

The user computing device 102 can store or include one or more teacher models 120 and one or more student models 122. For example, the teacher models 120 and student models 122 can be or can otherwise include various machine-learned models such as neural networks (e.g., deep neural networks) or other multi-layer non-linear models. Neural networks can include recurrent neural networks (e.g., long short-term memory recurrent neural networks), feed-forward neural networks, or other forms of neural networks. Example teacher models 120 and student models 122 are discussed with reference to FIGS. 2 through 4.

In some implementations, the teacher model(s) 120 and/or student model(s) 122 can be received from the server computing system 130 over network 180, stored in the user computing device memory 114, and used or otherwise implemented by the one or more processors 112. In some implementations, the user computing device 102 can implement multiple parallel instances of the teacher model(s) 120 and/or student model(s) 122 (e.g., to perform parallel operations across multiple instances of the model(s) 120 and/or model(s) 122).

Additionally or alternatively, one or more teacher model(s) 140 and/or student model(s) 142 can be included in or otherwise stored and implemented by the server computing system 130 that communicates with the user computing device 102 according to a client-server relationship. For example, the teacher model(s) 140 and/or student model(s) 142 can be implemented by the server computing system 130 as a portion of a web service (e.g., a machine-learned model training service). Thus, one or more models 120, 122 can be stored and implemented at the user computing device 102 and/or one or more models 140, 142 can be stored and implemented at the server computing system 130.

The user computing device 102 can also include one or more user input component 124 that receives user input. For example, the user input component 124 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 can be include one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more teacher machine-learned models 140 and/or student machine-learned models 142. For example, the models 140, 142 can be or can otherwise include various machine-learned models such as neural networks (e.g., deep recurrent neural networks) or other multi-layer non-linear models. Example models 140, 142 are discussed with reference to FIGS. 2 through 4.

The server computing system 130 can train the models 140, 142 via interaction with the training computing system 150 that is communicatively coupled over the network 180. The training computing system 150 can be separate from the server computing system 130 or can be a portion of the server computing system 130.

The training computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that can train the machine-learned models 140, 142 stored at the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train a teacher model 140 based on a set of training data 162. The training data 162 can include, for example, labeled and/or unlabeled training examples. The teacher model 140 can be deployed to the user computing device 102. The user computing device 102 can locally train the student model(s) 122 based on the teacher model(s) 120. For example, the user computing device 102 can train the student model(s) 122 based on input data, output data, user feedback, and/or other data collected by and/or stored by the user computing device 102.

In some implementations, if the user has provided consent, the training examples can be provided by the user computing device 102 (e.g., based on communications previously provided by the user of the user computing device 102). Thus, in such implementations, the models 120, 122 that are provided to the user computing device 102 can be trained by the training computing system 150 based on user-specific communication data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120, 122 can be both trained and used locally at the user computing device 102. In some of such implementations, the user computing device 102 can implement the model trainer 160 to personalize the models 120, 122 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Training Configuration

FIG. 2 depicts a block diagram of an example training configuration 200 according to example embodiments of the present disclosure. In some implementations, the training configuration 200 can include a teacher machine-learned model 202 and a student machine-learned model 204. The teacher machine-learned model 202 and/or student machine-learned model 204 can be stored by the user computing device 102. The teacher machine-learned model 202 can be deployed to the user computing device 102 (e.g., from the server computing system 130 and/or training computing system 150). The student machine-learned model 204 can similarly be deployed to the user computing device 102 and/or generated by the user computing device 102.

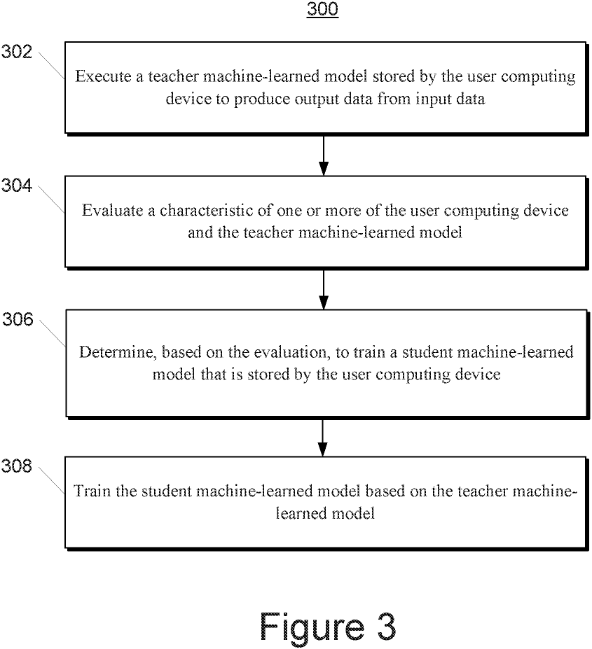

More specifically, the teacher machine-learned model 202 can be used, at the user computing device 102, to perform functions, such as text recognition, voice recognition, etc. The teacher machine-learned model 202 can further be trained with training input data 206 that can include user-specific data (e.g., user input and/or feedback with respect to inferences described by the teacher output data 208). The student machine-learned model 204 can be trained based on the teacher machine-learned model 202. Some or all of the training input data 206 can be input into the student machine-learned model 204, and student output data 212 can be received as an output from the student machine-learned model 204. Parameters of the student machine-learned model 204 can be adjusted based on a comparison between two or more of the teacher output data 208, the student output data 212, and/or the ground truth training data 210. Further, the teacher output data 208, the student output data 212, and/or the ground truth training data 210 can include data extracted from hidden layers of the teacher machine-learned model 202 and/or student machine-learned model 204. Parameters of the teacher machine-learned model 202 and/or student machine-learned model 204 can be adjusted based on comparisons of the teacher output data 208, student output data, and/or ground truth training data 210 (if available), for example as described below with reference to FIG. 3.

The parameters of the teacher machine-learned model 202 and/or student machine-learned model 204 can be adjusted based on one or more losses 214, 216 that describe such comparisons. For example, a student loss 214 can describe a comparison between the student output data 212 and the teacher output data 208 (and optionally the ground truth training data 210). The teacher loss 216 can describe a comparison between the teacher output data 208 and the ground truth training data 210. Thus, the parameters of the teacher machine-learned model 202 and/or student machine-learned model 204 can be adjusted based on one or more losses 214, 216.

### Example Methods

FIG. 3 depicts a flow chart diagram of an example method 300 for evaluating and selectively distilling machine-learned models on edge devices, according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure. Additionally, the method 300 is described with reference to the computing system 100 of FIG. 1 and the machine-learned model training configuration 200 of FIG. 2, it should be understood that the method 300 can be implemented with any suitable machine-learned model training configuration and any suitable computing system.

At 302, the method 300 can include executing, by a user computing device of a computing system, the teacher machine-learned model 202 stored by the user computing device to produce output data (e.g., the teacher output data 208) from the input data (e.g., the training input data 206). The teacher machine-learned model 202 can be configured to receive the input data (e.g., the training input data 206), and as a result of receipt of the input data, provide output data (e.g., teacher output data 208). The teacher machine-learned model 202 can be trained to perform various suitable functions, such as text recognition/analysis, voice recognition/analysis, image recognition/analysis, personal assistant functions, and/or any other suitable functions for the user computing device using suitable training input data 206. Training of the teacher machine-learned model 202 can be performed locally by the user computing device, and/or remotely by the server computing system 130 and/or training computing system 150.

At 304, the method 300 can include evaluating, by the computing system, one or more characteristics of the user computing device 102 and/or the teacher machine-learned model 202. The method 300 can include determining, based on the evaluation of the characteristic(s), to train the student machine-learned model 204 that is stored by the user computing device 102. The student machine-learned model 204 can be trained to replace the teacher machine-learned model 202 on the user computing device 102. The evaluated characteristics can include a variety of characteristics of the user computing device 102 and/or teacher machine-learned model 202. As one example, a characteristic of the teacher machine-learned model 202 can include one or more model performance metrics associated with executing the teacher machine-learned model 202 on the user computing device 102. For instance, the model performance metric can include an inference time of the teacher machine-learned model 202, such as an average inference time for the teacher machine-learned model 202. When the average inference time is detected as above a threshold inference time, the computing system can determine to train the student machine-learned model 204 to replace the teacher machine-learned model 202. As another example, a storage size of the teacher machine-learning model 202 can be compared with a threshold size to determine if the teacher machine-learning model 202 is too large. Thus, the student machine-learned model 204 can be generated and trained such that the student machine-learned model 204 is smaller and/or faster than the teacher machine-learned model 202 for local execution on the user computing device 102.

In some implementations, the evaluated characteristic can be or include a characteristic of the user computing device 102. For example, a decision be made to generate and/or train the student machine-learned model 202 to replace the teacher machine-learned model 204 when the user computing device 102 is not performing satisfactorily (e.g., poor battery life, limited on-device storage available, etc.). Such unsatisfactory performance can be caused or worsened by the computational demands of the teacher machine-learned model 202. Thus, the evaluated characteristic of the user computing device 102 can include one or more metrics associated with a battery life of the user computing device 102.

For example, when the battery life (e.g., average time that the user computing device can function normally without being charged) of the user computing device 102 is detected to be below a threshold metric, the student machine-learned model 204 can be trained to replace the teacher machine-learned model 202. As another example, the evaluated characteristic can be or include a processor capability and/or capacity of the user computing device 102. The student machine-learned model 204 can be trained in response to determining that the processor 112 of the user computing device 102 has insufficient processor capability to execute the teacher machine-learned model 202 within a desired time interval (e.g., total flops per second achievable by the processor, number of cores of the processor, etc.). For instance, a large teacher machine-learned model 122 can be deployed to a variety of user devices 102 having varying processor capabilities and/or memory capacities (e.g., random-access memory, storage memory, etc.). The teacher models 122 can be used to locally train student machine-learned models 122 that are customized based on the respective processor capabilities and/or memory capacities of the device 102.

In some implementations, student machine-learned model 204 can be generated and/or trained in response to determining that a quantify of training data 206 available to train the student machine-learned model 204 has exceeded a threshold. The evaluated characteristic can be or include the quantity of training data 206. As described below, the training data 206 can include user-specific data collected at the user computing device 102, for example during execution and/or training of the teacher machine-learned model 202. The user-specific data can include a user’s response to an output from the teacher machine-learned model 202. As an example, the teacher-machine-learned model 202 can provide an output (e.g., teacher output data 208) that describes a suggested auto-completion for text being entered by the user (e.g., the next word in a text string being entered by the user for a text message, e-mail or the like). The training input data 206 can include which word the user selects such that the training input data 206 describes the user’s writing style or preferences. As another example, the training input data 206 can voice recognition data that includes words that were incorrectly recognized by the teacher machine-learned model 202 and corrected by the user. Thus, the training input data 206 can include input data, output data, and/or user-feedback data with respect to the teacher machine-learned model 202.

At 308, the method 300 can include training the student machine-learned model 204 based on the teacher machine-learned model 202. The teacher output data 208 can be compared with the ground truth training data 210. Parameters of the student machine-learned model 204 can be adjusted based on the comparison between the ground truth training data 210 and the teacher output data 208. As one example, the parameters of the student machine-learned model 204 can be adjusted based on the teacher loss 216 that describes the comparison between the teacher output data 208 and the ground truth training data 210. As another example, the parameters of the student machine-learned model 204 can be adjusted based on student loss 214 that describes a comparison between the student output data 212 and the teacher output data 208 (and optionally the ground truth training data 210). Thus, the student machine-learned model 204 can be trained based on or more losses 214, 216 that describe comparisons of output data 208, 212 and/or ground truth training data 210.

Aspects of the training can also optionally be selected on the evaluation of the user computing device 102 and/or teacher machine-learned model 202. For instance, the student machine-learned model 204 can be iteratively trained until the student machine-learned model 204 satisfies one or more criteria, which can be based on characteristics of the teacher machine-learned model 202 (e.g., performance, size, etc.) and/or the user computing device 102 (e.g., available storage space, target inference time when executed on the user computing device). The student machine-learned model 204 can also be more compact than the teacher machine-learned model 202 while still providing sufficient accuracy. Thus, the student machine-learned model 204 can be customized for the user computing device 102 and/or trained to improve one or more characteristics as compared with the student machine-learned model 204.

As another example, one or more training characteristics (e.g., learning factor, number of training iterations, and other suitable aspects of training etc.) can be selected based on an average processing time for the student machine-learned model 204 and/or a storage size of the teacher machine-learned model 202. The average processing time of the teacher machine-learned 202 can be measured (e.g., for a predetermined task and/or input, for all tasks and/or inputs, etc.). The training characteristic(s) can be selected based on the average processing time of the teacher machine-learned model 202.

In some implementations, one or more target characteristics of the student machine-learned model 204 can be selected based on the evaluation of the characteristic(s) of the user computing device 102 and/or teacher machine-learned model 202. Example target characteristics can include a target storage size of the student machine-learned model 204, a target inference time of the student machine-learned model 204, or the like. The target storage size of the student machine-learned model 204 can be selected based on an available storage space of the user computing device 102 and/or available random access memory (RAM) of the user computing device 102.

As another example, the target characteristic(s) of the student machine-learned model 204 can include a kernel size of one or more layer of the student machine-learned model 204, a kernel depth of the layer(s), and/or a number of the layer(s). As a further example, an additional target characteristic can include a number of depthwise separable layers and a number of non-separable layers of the student machine-learned model 204. Thus, the target characteristics can be selected to adjust the structure and/or configuration of the student machine-learned model 204.

One or more of these target characteristics can be selected to provide a student machine-learned model 204 that is suitable for the particular user computing device 102 (e.g., can be executed within a threshold time interval, stored with a threshold memory size) and/or suitable for the type of task and/or particular task that the teacher machine-learned model 202 was trained to perform.

In some implementations, the student machine-learned model 204 can be transmitted to the user computing device 102, for example, in response to the determination that the student machine-learned model 204 should be trained. The student machine-learned model 204 can be transmitted from the server computing system 130, training computing system 150 other computing system or device. The student machine-learned model 204 can be transmitted in response to a request for the student machine-learned model 204. Alternatively, the user computing device 102 can transmit data describing the user computing device 102 and/or teacher machine-learned model 202 to the server computing device 130, which can evaluate the characteristic(s) to determine that the student machine-learned model 204 should be trained at the user computing device 102.

However, in other implementations, the student machine-learned model 204 can be generated on the user computing device 102. For example, the student machine-learned model 204 can be initiated based on pre-defined criteria, based on criteria generated based on the evaluation of the characteristics of the user computing device 102 and/or teacher machine-learned model 202, with predetermined neural values, and/or with randomized values.

In some implementations, the teacher machine-learned model 202 can be replaced with the student machine-learned model 204 at the user computing device 102. The student machine-learned model 204 can perform the same or similar operations as the teacher machine-learned model 202 but can require less inference time and/or storage space. Replacing the teacher machine-learned model 202 with the student machine-learned model 204 can include deleting the current variant and/or transmitting the current variant for storage at a storage location that is distinct from the user computing device 102 (e.g., a cloud computing storage location) to free up storage space on the user computing device. As another example, the teacher machine-learned model 202 can be stored or achieved at the user computing device 102 in a compressed file format.

In some implementations, training of the student machine-learned model 204 based on the teacher machine-learned model 202 can be selectively repeated, for example to re-calibrate the student machine-learned model 204. The student machine-learned model 204 can be used to perform operations previously performed by the teacher machine-learned model 202 at the user computing device 102. However, the student machine-learned model 204 may not be as equipped to be further personalized for the user, for example as the user’s preferences change. Performance characteristics of the student machine-learned model 204 and/or teacher machine-learned model 202 can be evaluated. Based on this evaluation, it can be determined that the student machine-learned model 204 would benefit from calibration. In such instances, the teacher machine-learned model 202 can be re-deployed to the user computing device 102 and re-trained based on new user data. Once the teacher machine-learned model 202 is performing suitably, the student machine-learned model 204 can be re-trained based on the updated teacher machine-learned model 202. The student machine-learned model 204 can again replace the teacher machine-learned model 202 at the user computing device 102. Thus, the student machine-learned model 204 can be selectively recalibrated based on the updated teacher machine-learned model 202.

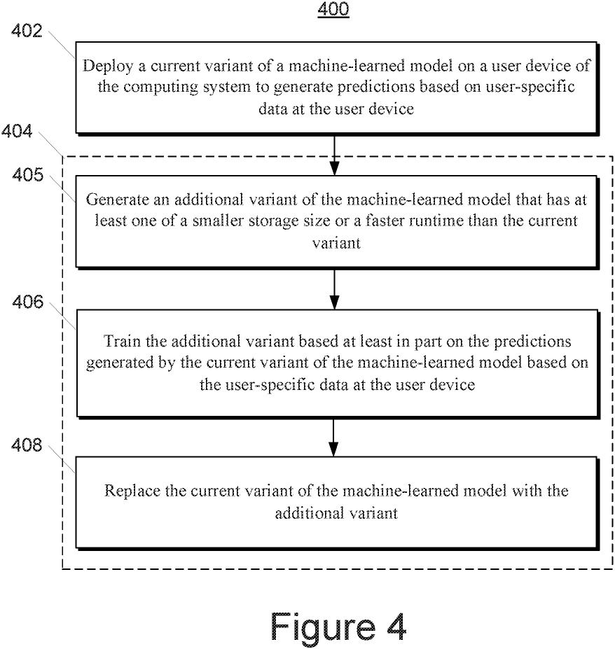

FIG. 4 depicts a flow chart diagram of an example method 400 for evaluating and selectively distilling machine-learned models on edge devices, according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure. Additionally, although the method 400 is described below with reference to the computing system 100 of FIG. 1 and the machine-learned model training configuration 200 of FIG. 2, it should be understood that the method 400 can be implemented with any suitable machine-learned model training configuration and any suitable computing system.

The method 400 can include deploying a current variant of a machine-learned model (e.g., the teacher machine-learned model 202) can be deployed on the user device 102 of the computing system 100 to generate predictions based on user-specific data (e.g., that is collected by the user device 102 and/or that is included in or described by the training input data 206) at the user device 102. The current variant (e.g., the teacher machine-learned model 202) can be used to perform text recognition/analysis, voice recognition/analysis, image recognition/analysis, personal assistant functions, and/or any other suitable functions for the user computing device.

The method 400 can include, performing one or more iterations, at 404, for training one more additional variants of the machine learned model. The iterations 404 can include generating, at 405, generating an additional variant (e.g., the student machine-learned model 204) of the machine-learned model that has at least one of a smaller storage size or a faster runtime than the current variant (e.g., the teacher machine-learned model 202). The additional variant (e.g., student machine-learned model 204) can be generated by the user computing device or a separate computing device (e.g., a server computing device).

The method 400 can include training, at the user device 102, the additional variant (e.g., student machine-learned model 204) based at least in part on the predictions generated by the current variant of the machine-learned model (e.g., the teacher machine-learned model 202) based on the user-specific data at the user device 102. The user-specific data can be descriptive of user preferences, user-feedback, or the like.

In some implementations, the iterations can be performed, at 404, until a performance metric of the additional variant satisfies one or more threshold criteria. For example, the iterations, at 404, can be performed until the storage size and/or an inference time of the additional variant (e.g., student machine-learned model 204) falls below a threshold value. As another example, the iterations can be performed, at 404, until an accuracy of the additional variant (e.g., student machine-learned model 204) is above an accuracy threshold. In some implementations, training can continue until a combination of two or more metrics are satisfied. Training parameters can be adjusted during training to achieve the desired combination of threshold criteria. Each additional variant can be deleted and/or transmitted for storage after each iteration. Thus, additional variants of the machine-learned model can be iteratively generated and/or trained until a variant of the machine-learned model is achieved that performs as desired according to one or more criteria.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method comprising:
executing, by a user computing device of a computing system, a teacher machine-learned model stored by the user computing device to produce output data from input data;
evaluating, by the computing system, a characteristic of one or more of the user computing device and the teacher machine-learned model;
determining, by the computing system and based on the evaluation, to train a student machine-learned model that is stored by the user computing device; and
training, by the user computing device, the student machine-learned model based on the teacher machine-learned model.

2. The computer-implemented method of claim 1, wherein the characteristic comprises a model performance metric associated with execution of the teacher machine-learned model by the user computing device.

3. The computer-implemented method of claim 1, wherein the characteristic comprises at least one of a battery life or a processor capability of the user computing device.

4. The computer-implemented method of claim 1, wherein the characteristic comprises a device performance metric associated with performance of the user computing device.

5. The computer-implemented method of claim 1, wherein the characteristic comprises a quantity of available training data collected by the user computing device during execution of the teacher machine-learned model.

6. The computer-implemented method of claim 1, further comprising, before determining, by the user computing device, to train the student machine-learned model based on the evaluation of the characteristic, generating, by the user computing device, the student machine-learned model.

7. The computer-implemented method of claim 1, further comprising before determining, by the user computing device, to train the student machine-learned model based on the evaluation of the characteristic, receiving, by the user computing device and from a computing device that is distinct from the user computing device, the student machine-learned model.

8. The computer-implemented method of claim 1, wherein training, by the user computing device, the student machine-learned model comprises training the student machine-learned model based on training data that comprises the input data used to produce the output data from the teacher machine-learned model when executing the teacher machine-learned model by the user computing device.

9. The computer-implemented method of claim 1, wherein training, by the user computing device, the student machine-learned model based on the teacher machine-learned model comprises training the student machine-learned model based on training data that comprises the output data produced by the teacher machine-learned model when executed by the user computing device.

10. The computer-implemented method of claim 1, wherein training, by the user computing device, the student machine-learned model based on the teacher machine-learned model comprises training the student machine-learned model based on user-specific training examples collected by the user computing device.

11. The computer-implemented method of claim 1, wherein training, by the user computing device, the student machine-learned model based on the teacher machine-learned model comprises selecting one or more target characteristics of the student machine-learned model based on the evaluation of the characteristic.

12. The computer-implemented method of claim 11, wherein target characteristics of the student machine-learned model based on the teacher machine-learned model comprises one or more of a target storage size of the student machine-learned model, a target inference time of the student machine-learned model.

13. The computer-implemented method of claim 11, wherein target characteristics of the student machine-learned model comprise one or more of a kernel size of one or more layers of the student machine-learned model, a kernel depth of the one or more layers, and a number of the one or more layers.

14. The computer-implemented method of claim 1, further comprising replacing, at the user computing device, the teacher machine-learned model with the student machine-learned model.

15. The computer-implemented method of claim 1, further comprising:
re-training, at the user computing device, the teacher machine-learned model to generate an updated teacher machine-learned model; and
re-training, at the user computing device, the student machine-learned model based on the updated teacher machine-learned model.

16. A computer-implemented method comprising:
deploying, by a computing system comprising one or more computing devices comprising a user computing device, a current variant of a machine-learned model on the user computing device of the computing system to generate predictions based on user-specific data at the user computing device;
for one or more iterations:
generating, by the computing system, an additional variant of the machine-learned model, wherein the additional variant of the machine-learned model has at least one of a smaller storage size or a faster runtime than the current variant;
training, at the user computing device, the additional variant based at least in part on the predictions generated by the current variant of the machine-learned model based on the user-specific data at the user computing device; and
replacing, at the user computing device, the current variant of the machine-learned model with the additional variant.

17. The computer-implemented method of claim 16, wherein the iterations are performed until a performance metric of the additional variant satisfies a threshold criteria.

18. The computer-implemented method of claim 17, wherein the performance metric comprises one or more of an accuracy or an inference time of the additional variant.

19. A user computing device comprising:
one or more processors; and
one or more non-transitory computer-readable media that collectively store instructions that, when executed by the one or more processors, cause the user computing device to:
execute a teacher machine-learned model stored by the user computing device to produce output data from input data;
evaluate a characteristic of one or more of the user computing device and the teacher machine-learned model;
determine, based on the evaluation of the characteristic, to train a student machine-learned model that is stored by the user computing device; and
train the student machine-learned model based on the teacher machine-learned model.

20. The user computing device of claim 19, wherein the characteristic comprises one or more of:
a model performance metric associated with execution of the teacher machine-learned model by the user computing device;
a battery life of the user computing device;
a processor capability of the user computing device;
a device performance metric associated with performance of the user computing device; and
a quantity of available training data collected by the user computing device during execution of the teacher machine-learned model.

21. The user computing device of claim 19, wherein training, by the user computing device, the student machine-learned model comprises training the student machine-learned model based on training data that comprises one or more of:
the input data used to produce the output data from the teacher machine-learned model when executing the teacher machine-learned model by the user computing device; and
the output data produced by the teacher machine-learned model when executed by the user computing device.
